(19) United States
(12) Patent Application Publication
(10) Pub. No.: US 2026/0116729 A1
(43) Pub. Date: Apr. 30, 2026

(54) INDUSTRIAL VEHICLE AND SAFETY SYSTEM THEREOF

(71) Applicant: DOOSAN BOBCAT KOREA CO., LTD., Incheon (KR)

(72) Inventor: Chulbae LIM, Incheon (KR)

(73) Assignee: DOOSAN BOBCAT KOREA CO., LTD., Incheon (KR)

(21) Appl. No.: 19/082,071

(22) Filed: Mar. 17, 2025

(30) Foreign Application Priority Data
Oct. 29, 2024 (KR) 10-2024-0149841

(51) Int. Cl. B66F 17/00

(52) U.S. Cl. CPC B66F 17/003

(57) ABSTRACT

An industrial vehicle and a safety system of the industrial vehicle are disclosed. The industrial vehicle according to an embodiment includes: a work machine configured to perform a vertical movement operation; a safety bar provided in a work machine, wherein a safety hook rope coupled with a safety band is connected to the safety bar and a recognition signal for an operator is input to the safety bar; a lift lever configured to output a signal according to an operator's operation for an operation of the work machine; and a processor configured to control an operation of the work machine based on the recognition signal and the signal output from the lift lever.

### CROSS-REFERENCE TO RELATED APPLICATION(S)

This application is based on and claims priority under 35 U.S.C. § 119 to Korean Patent Application No. 10-2024-0149841, filed on Oct. 29, 2024, in the Korean Intellectual Property Office, the disclosure of which is incorporated by reference herein in its entirety.

### BACKGROUND

### 1. Field

The disclosure relates to a safety device for an industrial vehicle, and more particularly, to a safety device for an industrial vehicle for preventing order picking while a safety hook is not connected.

### 2. Description of the Related Art

For order picking, various types of equipment are used. For example, there are conveyors, stackers, forklifts, order pickers, etc. An order picker is a type of forklift that raises vertically not only the fork but also the driver's seat.

The order picker is a forklift that can move vertically and horizontally with a small volume, and is order picking equipment recently most widely used as logistics transfer equipment.

Generally, the order picker uses a platform called a pallet to transport baggage. In other words, baggage is loaded onto the pallet and the order picker lifts the pallet by inserting the fork into the tunnel of the pallet.

Accordingly, the fork of the order picker is provided with a fixing device such as a pallet clamp device in order to support the weight of the pallet and baggage, transport the pallet and baggage, and prevent the pallet from departing from the fork during the transportation.

Conventional fixing devices require a driver's operation to couple the fork to the pallet or release the fork from the pallet, and include a safety hook for ensuring the driver's safety during such an operation.

However, because conventional order picker vehicles do not determine whether the safety hooks have been connected when starting and driving or working, there are cases where the vehicles are used even when the safety hooks are not connected, which may endanger the drivers who use the vehicles without wearing the safety hooks.

### SUMMARY

It is an aspect of the disclosure to provide a safety device for an industrial vehicle for preventing an operator's safety accident by determining whether a safety hook has been connected during starting, driving, and order picking of an order picker vehicle and restricting a vertical movement operation of a work machine when the safety hook has not been connected.

Additional aspects of the disclosure will be set forth in part in the description which follows and, in part, will be obvious from the description, or may be learned by practice of the disclosure.

According to an aspect of the disclosure, an industrial vehicle may include a work machine configured to perform a vertical movement operation, a safety bar provided in a work machine, wherein a safety hook rope coupled with a safety band is connected to the safety bar and a recognition signal for an operator is input to the safety bar, a lift lever configured to output a signal according to an operator's operation for an operation of the work machine, and a processor configured to control an operation of the work machine based on the recognition signal and the signal output from the lift lever.

According to an aspect to the disclosure, the processor may be configured to determine whether the recognition signal corresponds to an operator set for a current time.

According to an aspect to the disclosure, the processor may be configured to restrict a vertical movement operation of the work machine when the recognition signal is not obtained, when the recognition signal does not correspond to the operator set for the current time, or when the recognition signal is no longer obtained.

According to an aspect to the disclosure, the safety bar may include a pipe, an insulating member surrounding the pipe, and a conductive member surrounding the insulating member.

According to an aspect to the disclosure, both ends of the safety bar may be fixed to the industrial vehicle, a preset width of the insulating member may be exposed to outside at an end of the safety bar, and a connector for transmitting a signal input to the safety bar to the processor may be connected to the preset width of the insulating member.

According to an aspect to the disclosure, the industrial vehicle may further include a warning device including at least one of an indicator, a buzzer, a display, and a vibrator.

According to an aspect to the disclosure, the processor may be configured to turn on a green light of the indicator when an operation of the work machine is allowed, and turn on a red light of the indicator and operate the buzzer when an operation of the work machine is restricted.

According to an aspect to the disclosure, in a safety system including an industrial vehicle and a safety device connected to the industrial vehicle and configured to transmit a recognition signal for an operator to the industrial vehicle, the industrial vehicle may include a work machine configured to perform a vertical movement operation, a safety bar provided in a work machine, wherein a safety hook rope coupled with a safety band is connected to the safety bar and a recognition signal for an operator is input to the safety bar, a lift lever configured to output a signal according to an operator's operation for an operation of the work machine, and a processor configured to control an operation of the work machine based on the recognition signal and the signal output from the lift lever, wherein the safety device may include a transponder installed on the safety band and configured to output a recognition signal for the operator, and a safety hook rope including a rope, a first hook provided at an end of the rope and detachably coupled to the safety bar provided in the work machine of the industrial vehicle, a wiring member connecting the first hook and the transponder, and a second hook provided at another end of the rope and detachably coupled to the safety band.

According to an aspect to the disclosure, the recognition signal may be output from the transponder and input to the safety bar through the wiring member and the first hook.

According to an aspect to the disclosure, the processor may be configured to determine whether the recognition signal corresponds to an operator set for a current time.

According to an aspect to the disclosure, both ends of the safety bar may be fixed to the industrial vehicle, the safety bar may include a pipe, an insulating member surrounding the pipe, and a conductive member surrounding the insulating member, a preset width of the insulating member may be exposed to outside at an end of the safety bar, and a connector for transmitting a signal input to the safety bar to the processor may be connected to the preset width of the insulating member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 schematically shows a configuration of an industrial vehicle;

FIG. 2 schematically shows a configuration of a transponder;

FIG. 3 schematically shows a configuration of a safety device according to an embodiment of the disclosure;

FIG. 4 shows a configuration of a safety bar according to an embodiment of the disclosure;

FIG. 5 shows a cross section of a safety bar according to an embodiment of the disclosure and a state in which a safety hook is coupled to the safety bar; and

FIG. 6 shows an installation method of a safety device according to an embodiment of the disclosure.

### DETAILED DESCRIPTION

Like reference numerals refer to like components throughout the specification. This specification does not describe all the components of the embodiments, and duplicative contents between embodiments or general contents in the technical field to which the disclosure belongs will be omitted. The terms ‘portion,’ ‘module,’ ‘member,’ and ‘block’ used in this specification may be embodied as software or hardware, and it is also possible for a plurality of ‘portions,’ ‘modules,’ ‘members,’ and ‘blocks’ to be embodied as one component, or one ‘portion,’ ‘module,’ ‘member,’ and ‘block’ to include a plurality of components according to embodiments.

Throughout the specification, when a portion is referred to as being “connected” to another portion, it includes not only a direct connection but also an indirect connection, and the indirect connection includes connecting through a wireless network.

Also, when it is described that a portion “includes” a component, it means that the portion may further include other components, not excluding the other components unless specifically stated otherwise.

Throughout the specification, when a member is described as being “on” another member, this includes not only a case in which a member is in contact with another member but also a case in which another member is present between the two members.

The terms “first”, “second”, etc. are used to distinguish one component from another component, and the components are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter, the operation principle and embodiments of the disclosure will be described with reference to the accompanying drawings.

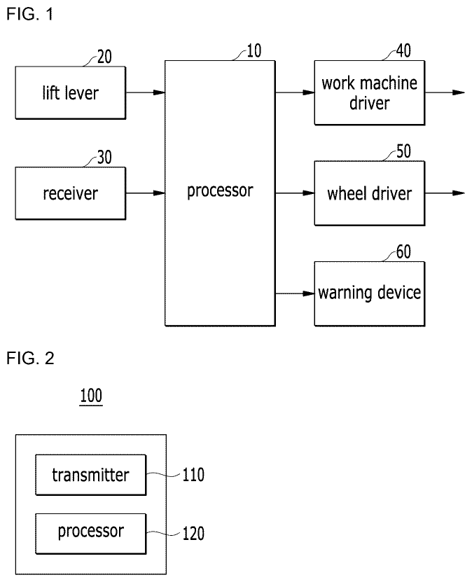

FIG. 1 schematically shows a configuration of an industrial vehicle 1, and FIG. 2 schematically shows a configuration of a transponder 100.

As shown in FIG. 1, the industrial vehicle 1 may include a processor 10 that controls overall operations of the industrial vehicle 1, a lift lever 20 that outputs a signal according to an operator's operation for a vertical movement operation such as changing a height of a work machine 21 and inputs the signal to the processor 10, a receiver 30 for receiving a signal such as data from another device, a work machine driver 40 that drives the work machine 21 according to a control signal from the processor 10, and a wheel driver 50 that drives a wheel for a driving operation of the industrial vehicle 1 according to a control signal from the processor 10.

Also, although not shown, the industrial vehicle 1 may include a body provided with a driver's cabin which a driver gets on and a display device for displaying information, and the wheel driver 50 may include a front wheel, a rear wheel, a driving motor, and a driving motor control module. In addition, conventional technical configurations (for example, an accelerator pedal, a brake pedal, a steering wheel, a lamp, a speaker, etc.) for controlling driving of the industrial vehicle 1 or a vehicle and controlling internal functions of the industrial vehicle 1 or the vehicle may be preferably provided inside and outside the driver's cabin.

The driving motor and the driving motor control module may be provided between the front wheel and the rear wheel below a bottom of the driver's cabin.

The driving motor control module may drive the driving motor in a first rotation direction or a second rotation direction to perform a forward movement of the front wheel and the rear wheel according to the first rotation direction or a backward movement of the front wheel and the rear wheel according to the second rotation direction.

Meanwhile, the driving motor control module may generate motor current for driving the driving motor in the first rotation direction or the second rotation direction, and apply the motor current to the driving motor. For example, the driving motor control module may include a H-Bridge circuit configured with a plurality of power switching elements to drive the driving motor in the first rotation direction or the second rotation direction.

Meanwhile, the work machine 21 may be provided in front of the body and perform tasks such as unloading, transporting, and loading a load A according to a driver's operation.

For example, the work machine 21 may include a carriage capable of rising upward or falling downward along a mast rail, and a pair of forks connected to the carriage, and the work machine 21 may move vertically, that is, in an upward or downward direction, by the work machine driver 40.

Meanwhile, the industrial vehicle 1 may include a memory (not shown), and the memory may be connected to the processor 10.

For example, the memory may store various programs and data required for operations of the processor 10, and a communication device may communicate with an external device. Particularly, the receiver 30 may perform communication according to various communication standards by including various communication chips, such as a Wireless-Fidelity (Wi-Fi) chip, a Bluetooth chip, a wireless communication chip, a Near Field Communication (NFC) chip, a Bluetooth Low Energy (BLE) chip, etc., and the processor 10 may perform overall operations by using data obtained through the receiver 30 and the various programs stored in the memory.

The work machine driver 40 may include a direction switching control valve that operates the working machine 21 in the upward direction or the downward direction to control a height of the work machine 21. More specifically, the direction switching control valve may be provided as a hydraulic block equipped with a rising valve and a lowering valve, and control opening and closing of flow paths of the rising valve and the lowering valve to raise and lower the work machine 21.

More specifically, the work machine driver 40 may set a work mode of the work machine 21 based on rising or lowering of the work machine 21. At this time, the work machine driver 40 may control opening or closing of the flow paths of the rising valve and the lower valve by setting a work mode for raising or lowering the work machine 21 and a rising/lowering stop mode for restricting rising and lowering of the work machine 21, based on an output from the lift lever 20 by a driver's operation.

Meanwhile, the lift lever 20 may output a rising/lowering selection signal to select rising, lowering, or stopping of the work machine 21 based on an operation state, and input the rising/lowering selection signal to the processor 10.

Based on the rising/lowering selection signal, the processor 10 may control and restrict a vertical movement of the work machine 21 through the work machine driver 40.

Meanwhile, as shown in FIG. 2, the transponder 100 may include a transmitter 110 for transmitting a signal, and a processor 120 for performing overall operations (for example, outputting signals, etc.) of the transponder 100.

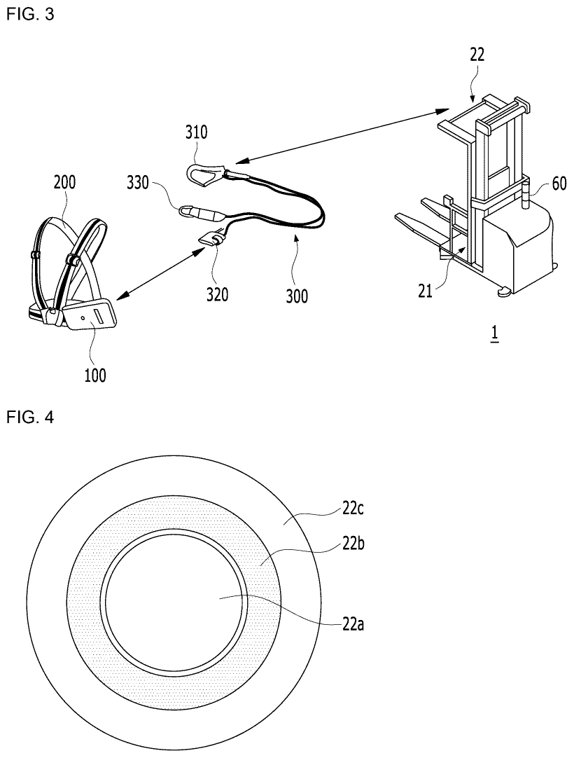

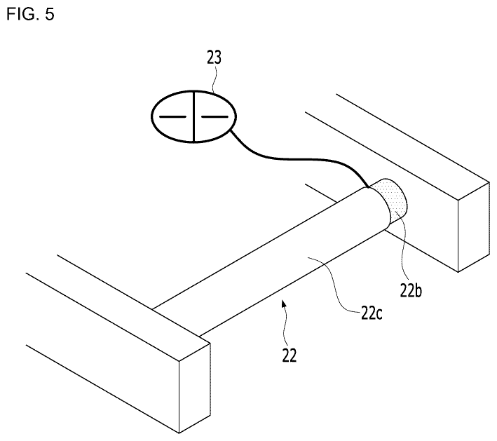

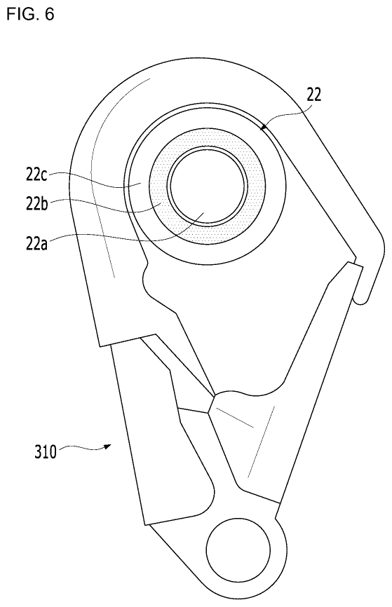

FIG. 3 schematically shows a configuration of a safety device according to an embodiment of the disclosure, FIG. 4 shows a configuration of a safety bar according to an embodiment of the disclosure, FIG. 5 shows a cross section of a safety bar according to an embodiment of the disclosure and a state in which a safety hook is coupled to the safety bar, and FIG. 6 shows an installation method of a safety device according to an embodiment of the disclosure.

As shown in FIG. 3, the industrial vehicle 1 according to an aspect of the disclosure may further include the lift lever 20, the work machine 21, and a safety bar 22, and the safety device may include the transponder 100 and a safety hook rope 300.

In this case, the industrial vehicle 1 may be connected to the safety device by a structure that performs signal transmission/reception between the transponder 100 and the processor 10 by a connection relationship between a wiring member 320 connected to the transponder 100, a first hook 310, and the safety bar 22.

More specifically, the processor 10 may recognize an operator wearing a safety band 200 and a coupling state between the safety hook rope 300 and the safety bar 22, based on a recognition signal output from the transponder 100 and input to the safety bar 22 through the wiring member 320 and the first hook 310, and control an operation of the work machine 21.

Accordingly, the processor 10 may control and restrict a vertical movement of the work machine 21 through the work machine driver 40, and the industrial vehicle 1 may further include a warning device 60 that communicates with the processor 10.

Meanwhile, referring to FIG. 3, the industrial vehicle 1 may further include the warning device 60.

The warning device 60 may be provided in the industrial vehicle 1 and controlled by the processor 10, or the warning device 60 may be provided as a component separated from the industrial vehicle 1 and including a separate receiver and operate by receiving a control signal from the processor 10.

Also, the warning device 60 may include at least one of an indicator, a buzzer, a display, and a vibrator.

Accordingly, the processor 10 may turn on a green light of the indicator while an operation of the work machine 21 is allowed, and when an operation of the work machine 21 is restricted, the processor 10 may turn on a red light of the indicator and operate the buzzer.

Meanwhile, the transponder 100 may be installed on the safety band 200 and output a recognition signal for an operator wearing the safety band 200.

Referring to FIG. 3, the safety band 200 may be an X-shaped band which an operator wears on his/her upper body, but is not limited thereto.

The transponder 100 may output a signal including a recognition signal (for example, a unique number, ID, etc.) for an operator.

At this time, when the recognition signal is input to the safety bar 22 through the wiring member 320 connected to the transponder 100 and the first hook 310, the processor 10 may obtain the recognition signal input to the safety bar 22, and determine whether the operator identified according to the recognition signal corresponds to an operator set for a current time.

Accordingly, when the processor 10 fails to obtain a recognition signal, the processor 10 may determine that coupling between the first hook 310 and the safety bar 22 or coupling between a second hook 330 and the safety band 200 has not been performed.

Also, when a recognition signal is no longer obtained, the processor 10 may determine that coupling between the first hook 310 and the safety bar 22 or coupling between the second hook 330 and the safety band 200 has been released.

To this end, the processor 10 may monitor whether a signal is input to the safety bar 22 periodically or in real time through the receiver 30, and when the processor 10 fails to obtain a signal from the safety bar 22 through the receiver 30 or when a signal input to the safety bar 22 is interrupted and thus a signal is no longer obtained from the safety bar 22, the processor 10 may determine that coupling between the first hook 310 and the safety bar 22 or coupling between the second hook 330 and the safety band 200 has been released.

When the processor 10 determines that coupling between the first hook 310 and the safety bar 22 or coupling between the second hook 330 and the safety band 200 has not been performed or that coupling between the first hook 310 and the safety bar 22 or coupling between the second hook 330 and the safety band 200 has been released, the processor 10 may process a signal received from the lift lever 20 as a default or stop the work machine 21, thereby restricting a vertical movement of the work machine 21.

Also, when the operator identified based on the recognition signal does not correspond to the operator set for the current time, that is, when the identified operator is an unauthorized operator who is not a person set for the current time, the processor 10 may restrict a vertical movement of the work machine 21 by processing a signal received from the lift lever 20 as a default or stopping the work machine 21, to allow only an authorized operator to operate the lift lever 20, thereby managing safety responsibility issues and security issues.

The safety hook rope 300 may include a rope, the first hook 310, the wiring member 320, and the second hook 330. For example, the safety hook rope 300 may be a fall prevention safety block including the wiring member 320, and accordingly, the first hook 310 and the second hook 330 may be in the form of, for example, a carabiner, a hook, or the like, but are not limited thereto.

More specifically, the first hook 310 may be provided at an end of the rope and attached to or detached from the safety bar 22, as shown in FIGS. 3 to 6.

The wiring member 320 may be coupled to or separated from the transponder 100. While the wiring member 320 is coupled to the transponder 100, the transponder 100 may be electrically connected to the safety bar 22 through the wiring member 320 and the first hook 310 such that a recognition signal output from the transponder 100 is input to the safety bar 22.

Also, the second hook 330 may be provided at another end of the rope, and attached to or detached from the safety band 200. The second hook 330 may connect the safety band 200 to the safety bar 22 to prevent an operator from falling from the work machine 21.

Meanwhile, the safety bar 22 may be provided in the work machine 21 that performs a vertical movement operation of the industrial vehicle 1, as shown in FIG. 3, and the second hook 330 may be attached to or detached from the safety bar 22, as shown in FIG. 6.

The safety bar 22 to which the second hook 330 is connected may be electrically connected to the transponder 100 through the second hook 330 and the wiring member 320.

Therefore, the processor 10 may determine a coupling state of the safety hook rope 300 and the safety bar 22, based on whether a signal for the safety bar 22 has been received.

To this end, the safety bar 22 may include a pipe 22a, an insulating member 22b, and a conductive member 22c, as shown in FIGS. 4 to 6.

As shown, the safety bar 22 may be configured such that the pipe 22a is primarily surrounded by the insulating member 22b and maintained in an insulated state, and the pipe 22a surrounded by the insulating member 22b is secondarily surrounded by the conductive member 22c. In this case, the insulating member 22b may be made of an insulating material, and the conductive member 22c may be made of a conductive material.

In this case, as shown in FIG. 5, in the safety bar 22 of which both ends are fixed to the industrial vehicle 1, a preset width of the insulating member 22b may be exposed to outside at an end of the safety bar 22, and a connector 23 for transmitting a signal input to the safety bar 22 to the receiver 30 to transfer the signal to the processor 10 may be provided in the preset width of the insulating member 22b.

By the configuration of the safety bar 22, the safety bar 22 may be electrically connected to the transponder 100 through the first hook 310 and the wiring member 320, and when a signal output from the transponder 100 is input to the safety bar 22, the safety bar 22 may transmit the signal to the receiver 30 through the connector 23 to input a recognition signal to the processor 10, as shown in FIG. 1.

According to an aspect of the disclosure, a situation in which an operator falls from the work machine due to a rising/lowering operation of the work machine, performed by an operation of the work machine driver such as operating the lift lever while the safety hook is not connected to the safety bar, may be prevented.

Also, according to an aspect of the disclosure, a situation in which an operator unauthorized for a certain operation time performs a rising/lowering operation of the work machine may be prevented.

Also, according to an aspect of the disclosure, by displaying a situation in which normal use of the work machine is possible and a situation in which normal use of the work machine is impossible through the warning device to notify an operator of such situations and enable a manager to confirm the situations, safety inspection for a workplace may be supported.

The above-described disclosure may be implemented as computer-readable codes on a computer-readable medium storing programs. The computer-readable medium may include all kinds of recording devices storing data that can be read by a computer system. Examples of the computer-readable medium may be Hard Disk Drive (HDD), Solid State Disk (SSD), Read Only Memory (ROM), Random Access Memory (RAM), Compact Disk-Read Only Memory (CD-ROM), a magnetic tape, a floppy disk, an optical data storage device, etc. Also, the computer-readable medium may be implemented in the form of carrier waves (transmission over the Internet). Thus, it should be understood that the above detailed descriptions are merely for illustrative purposes and not for limitation purposes in all aspects. The scope of the disclosure should be defined by rational interpretation of the attached claims, and all modifications falling within equivalents of the disclosure are included in the scope of the disclosure.

So far, although the disclosure has been described based on embodiments, these embodiments are only examples, not intended to limit the disclosure. It will be understood by one of ordinary skill in the art to which the disclosure belongs that various modifications and applications are possible within the scope that does not depart from the gist of the embodiments. For example, components described in detail in the embodiments may be modified and embodied. Also, it should be interpreted that differences related to such modifications and applications are included in the scope of the disclosure defined in the attached claims.

What is claimed is:

1. An industrial vehicle comprising:
a work machine configured to perform a vertical movement operation;
a safety bar provided in a work machine, wherein a safety hook rope coupled with a safety band is connected to the safety bar and a recognition signal for an operator is input to the safety bar;
a lift lever configured to output a signal according to an operator's operation for an operation of the work machine; and
a processor configured to control an operation of the work machine based on the recognition signal and the signal output from the lift lever.

2. The industrial vehicle of claim 1, wherein
the processor is configured to determine whether the recognition signal corresponds to an operator set for a current time.

3. The industrial vehicle of claim 2, wherein
the processor is configured to restrict a vertical movement operation of the work machine when the recognition signal is not obtained, when the recognition signal does not correspond to the operator set for the current time, or when the recognition signal is no longer obtained.

4. The industrial vehicle of claim 1, wherein
the safety bar comprises:
a pipe;
an insulating member surrounding the pipe; and
a conductive member surrounding the insulating member.

5. The industrial vehicle of claim 4, wherein
both ends of the safety bar are fixed to the industrial vehicle, and
a preset width of the insulating member is exposed to outside at an end of the safety bar, wherein a connector configured to transmit a signal input to the safety bar to the processor is connected to the preset width of the insulating member.

6. The industrial vehicle of claim 1, further comprising
a warning device including at least one of an indicator, a buzzer, a display, and a vibrator.

7. The industrial vehicle of claim 6, wherein
the processor is configured to
turn on a green light of the indicator when an operation of the work machine is allowed, and
turn on a red light of the indicator and operate the buzzer when an operation of the work machine is restricted.

8. A safety system including an industrial vehicle and a safety device connected to the industrial vehicle and configured to transmit a recognition signal for an operator to the industrial vehicle, the industrial vehicle comprising:
a work machine configured to perform a vertical movement operation;
a safety bar provided in a work machine, wherein a safety hook rope coupled with a safety band is connected to the safety bar and a recognition signal for an operator is input to the safety bar;
a lift lever configured to output a signal according to an operator's operation for an operation of the work machine; and
a processor configured to control an operation of the work machine based on the recognition signal and the signal output from the lift lever,
wherein the safety device comprises:
a transponder installed on the safety band and configured to output a recognition signal for the operator; and
a safety hook rope including a rope, a first hook provided at an end of the rope and detachably coupled to the safety bar provided in the work machine of the industrial vehicle, a wiring member connecting the first hook and the transponder, and a second hook provided at another end of the rope and detachably coupled to the safety band.

9. The safety system of claim 8, wherein
the recognition signal is output from the transponder and input to the safety bar through the wiring member and the first hook.

10. The safety system of claim 8, wherein
the processor is configured to determine whether the recognition signal corresponds to an operator set for a current time.

11. The safety system of claim 8, wherein
both ends of the safety bar are fixed to the industrial vehicle,
the safety bar comprises a pipe, an insulating member surrounding the pipe, and a conductive member surrounding the insulating member, and
a preset width of the insulating member is exposed to outside at an end of the safety bar, wherein a connector configured to transmit a signal input to the safety bar to the processor is connected to the preset width of the insulating member.
